(19) United States
(12) Patent Application Publication
(10) Pub. No.: US 2016/0124122 A1
(43) Pub. Date: May 5, 2016

(54) Optical Article Comprising an Acrylic Substrate Coated with a Specific Hard-Coat

(71) Applicant: ESSILOR INTERNATIONAL (COMPAGNIE GENERALE D'OPTIQUE), Charenton Le Pont (FR)

(72) Inventors: Olivier Duc, Charenton Le Pont (FR); Hui Yu, Singapore (SG); Yangiong Qi, Singapore (SG); Kian Soon Yong, Singapore (SG)

(73) Assignee: ESSILOR INTERNATIONAL (COMPAGNIE GENERALE D'OPTIQUE), Charenton Le Pont (FR)

(21) Appl. No.: 14/889,612

(22) PCT Filed: May 7, 2013
(86) PCT No.: PCT/IB2013/001770

§ 371 Date: Nov. 6, 2015

(51) Int. Cl. G02B 1/14; C08K 3/22; C08K 5/1515; G02C 7/02; C09D 183/06

(52) U.S. Cl. CPC G02B 1/14; G02C 7/02; C09D 183/06; C08K 5/1515; C08K 3/22; G02C 2202/16; C08K 2003/2241; C08K 2003/2244; C08K 2003/2213; C08K 2003/2231

(57) ABSTRACT

This invention is related to an optical article, such as an ophthalmic lens, comprising a an acrylic substrate (1) coated with a specific hard-coat (2) formed from a composition comprising a hydrolyzed alkoxysilane, a colloidal metal oxide and a poly-glyceryl ether.

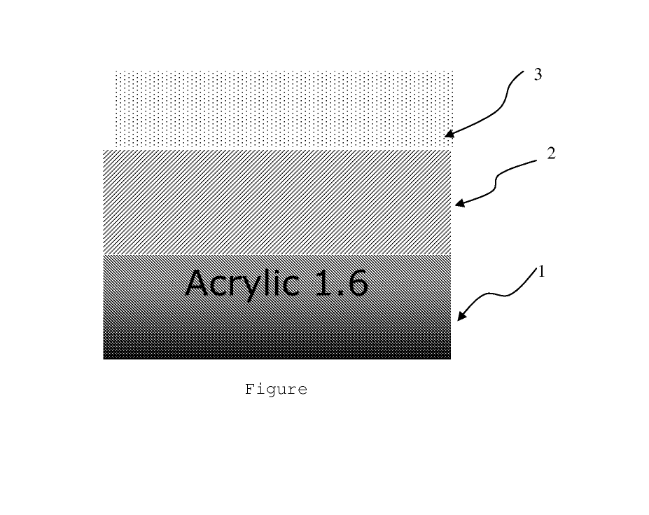

### FIELD OF THE INVENTION

The present invention pertains to an ophthalmic lens comprising an acrylic substrate and a specific coating composition which is applied on said substrate. This combination exhibits good performance in terms of adhesion and abrasion resistance while keeping high optical quality.

### BACKGROUND OF THE INVENTION

Ophthalmic lenses of transparent organic material are lighter than mineral glass and are now widely used. Among the polymers used as organic glass for ophthalmic lenses, mention can be made of acrylic polymers. They have the advantage of existing in low-haze, high transparency compositions, with a high refractive index of about 1.6, which are relatively cheap to manufacture.

A main problem with organic glass such as acrylic substrates is that it is more sensitive to scratching and abrasion than conventional mineral glass. It is well-known to apply an abrasion resistant coating composition onto the surface of an organic substrate for forming a hard-coat which improves the surface mechanical properties such as scratch resistance and/or abrasion resistance. However, the acrylic substrates are known to provide poor adhesion to their coatings.

The inventors have now discovered that a specific coating composition could be used as a hard-coat for an acrylic substrate and that, surprisingly, such assembly exhibits high performance in terms of adhesion between the substrate and the hard-coat and abrasion resistance, while keeping high optical quality.

Moreover, the inventors have shown that this coating could be applied to an acrylic substrate, without the need for any physical pre-treatment of the substrate like plasma, corona or UV irradiation, or inserting a primer coating (such as a polyurethane latex or an aminosilane layer) between the substrate and the hard-coat in order to improve the adhesion of the hard-coat. In particular, the use of trimethylopropane triglycidyl ether (TMPTGE) in the coating composition used in the present invention significantly enhances the adhesion of the coating to acrylic substrates.

This invention thus offers a way to produce low-cost ophthalmic lenses with high production yield, because it does not require expensive treatments of the substrate.

### SUMMARY OF THE INVENTION

A first object of this invention is to provide an abrasion resistant coating (or hard-coat) that has good abrasion resistance and adhesion to acrylic substrates, whether such substrates have been pretreated or not.

A second objet of the invention is to provide an abrasion resistant coating, which provides, once cured, a good adhesion of subsequent coatings deposited thereon, without requiring additional physical pretreatment steps, such as corona or plasma pretreatment.

The inventors have designed an ophthalmic lens having the properties described above by applying onto an acrylic substrate a high refractive index anti-abrasion coating composition which comprises specific compounds and carefully controlling their respective amounts.

This invention is thus directed to an ophthalmic lens comprising:

(a) an acrylic substrate,

(b) an abrasion-resistant coating applied onto at least one surface of said substrate and obtained by curing a composition comprising the following constituents:
(a) a monomeric compound of hydrolyzed alkoxysilane representing from 10 to 95 dry wt % of the dry weight of the composition,
(b) at least one colloidal metal oxide compound selected from titanium, zirconium, cerium, niobium, tantalum, and/or tin;
(c) a polyglycidyl ether representing from 1 to 65 dry wt % of the dry weight of the composition,
with the proviso that the total amount of these constituents does not exceed 100 dry wt. % of the dry weight of the composition.

In a preferred embodiment of the invention, the coating composition further includes a metal alkoxide (d), which is capable of reacting with the hydrolyzed alkoxysilane.

The invention further relates to a method for manufacturing an ophthalmic lens, comprising:
providing an acrylic substrate,
applying an anti-abrasion coating composition onto at least one surface of said substrate, said coating composition comprising the following constituents:
(a) a monomer compound of hydrolyzed alkoxysilane representing from 10 to 95 dry wt % of the dry weight of the composition,
(b) at least one colloidal metal oxide compound selected from titanium, zirconium, cerium, niobium, tantalum, and/or tin;
(c) a polyglycidyl ether representing from 1 to 65 dry wt % of the dry weight of the composition,
with the proviso that the total amount of these constituents does not exceed 100 dry wt. % of the dry weight of the composition,
curing the coating composition at a temperature ranging from 120° C. to 135° C., and preferably at 120° C. for a period of between 2 and 3 hours.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWING

The FIGURE depicts one embodiment of an ophthalmic lens of the invention comprising an acrylic substrate, a hard coat deposited on the substrate and a functional layer deposited on the hard coat.

### DETAILED DESCRIPTION OF THE INVENTION

The abrasion-resistant thermally curable coating composition used in the present invention comprises and preferably consists in the mixture of following compounds as defined hereafter, and used in the following respective amounts:
(a) a monomer compound of hydrolyzed alkoxysilane representing from 10 to 95 dry wt % of the dry weight of the composition,
(b) at least one colloidal metal oxide compound selected from titanium, zirconium, cerium, niobium, tantalum, and/or tin;
(c) a polyglycidyl ether representing from 1 to 65 dry wt % of the dry weight of the composition,
with the proviso that the total amount of these constituents does not exceed 100 dry wt. % of the dry weight of the composition.

According to a preferred embodiment, the alkoxysilane used in the coating composition may have the following formula:

(R¹O)₃₋ₙSi(R³)ₙ—W

wherein:
R¹ is selected from: an alkyl group with 1 to 6 carbon atoms, preferably a methyl or ethyl group, an acetyl group, or a hydrogen atom,
R³ is a non-hydrolyzable group, such as an alkyl group having from 1 to 6 carbon atoms, preferably a methyl group,
n is 0 or 1, preferably 0,
W is an organic group containing at least one epoxy group, such as a —(CH₂)ₘ—Y group, wherein m ranges from 1 to 6 and is preferably 3, and Y is:

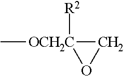

wherein R² is a methyl group or a hydrogen atom, preferably a hydrogen atom.
The following are examples of such alkoxysilanes: γ-glycidoxypropyl trimethoxysilane, γ-glycidoxypropyl-triethoxysilane and γ-glycidoxypropyl methyldiethoxy-silane. γ-glycidoxypropyl trimethoxysilane (GLYMO) is preferably used in this invention.

In another embodiment, the alkoxysilane may be selected among compound having the following formula:

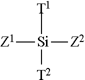

wherein the two groups T¹ and T² are independently selected from alkoxy groups with 1 to 10 carbon atoms, and Z¹ and Z² are independently selected from alkoxy groups with 1 to 10 carbon atoms, alkyl groups with 1 to 10 carbon atoms and aryl groups with 6 to 10 carbon atoms, such as a phenyl group. Examples of such alkoxysilanes are: dimethyldimethoxysilane, dimethyldiethoxysilane (DMDES), methylphenyldimethoxy-silane and tetraethylorthosilicate (TEOS).

For the purpose of the present invention, one preferably uses γ-glycidoxypropyltrimethoxysilane (GLYMO). This alkoxysilane is hydrolyzed before being mixed to the other components of the composition, so as to produce the abrasion-resistant coating, using known sol-gel processes. The hydrolysis may be performed as known in the art, by using acidic catalysts such as hydrochlorodric acid, sulphuric acid, phosphoric acid, nitric acid and acetic acid, in the presence of water. The amount of the alkoxysilane ranges from 10 to 95 dry wt %, preferably from 10 to 50 dry wt. % and more preferably from 15 to 30 dry wt. % of the dry weight of the composition.

After hydrolysis, at least one colloidal metal oxide compound selected from titanium, zirconium, cerium, niobium, tantalum, tin and mixture of these compounds is dispersed in the alkoxysilane hydrolyzate. The metal oxide is preferably a cerium oxide. The amount of metal oxide may range from 1 to 10 dry wt. % and preferably from 2 to 5 dry wt. % of the dry weight of the composition.

In a preferred embodiment, a metal alkoxide such as titanium n-butoxide is introduced into the mix thus obtained. The amount of metal alkoxide may range from 1 to 50 dry wt. % and preferably from 10 to 25 dry wt. % of the dry weight of the composition.

The coating composition used in this invention further comprises a polyglycidyl ether representing from 1 to 65 dry wt % of the dry weight of the composition. The amount of polyglycidyl ether may preferably range from 1 to 50 dry wt. % and more preferably from 5 to 20 dry wt. % of the dry weight of the composition. In a preferred embodiment, example of polyglycidyl ether which can be used is trimethylopropane triglycidyl ether (TMPTGE). It has been found that such compound contributed to the improvement of adhesion to an acrylic substrate.

This composition may further include various additives such as wetting agents, surfactants, pigments, coloring agents, acids and bases, for instance.

As shown on the attached drawing, the above coating composition 2 may be applied, for instance by dip or spin coating, onto a transparent acrylic substrate 1.

The substrate on which the thermally abrasion-resistant coating composition described above is applied is an acrylic substrate classically used in optics and ophthalmology. For example, such substrate may be obtained by polymerizing a composition comprising at least one (meth)acrylate monomer and optionally an aromatic vinyl monomer.

By a (meth)acrylate monomer, it is meant a functional group of formula:

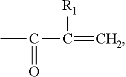

wherein R₁ is H or —CH₃.

Preferably, the (meth)acrylate monomers have the following formula:

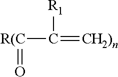

wherein:

R is a linear or branched, monovalent or polyvalent, aliphatic or aromatic hydrocarbon radical,

R₁ is H or —CH₃ and

n is an integer from 1 to 6; preferably from 1 to 3 inclusive.

The aromatic vinyl monomer may be a monomer of formula:

[(CH₂═CH)(A)ₐ]_{b}B

wherein:

B represents a group selected from phenyl, biphenyl, naphtyl and phenyltholyl groups, wherein each of these groups may be mono-substituted or di-substituted by halogen atoms or alkyl groups with 1 to 6 carbon atoms, preferably a phenyl group which is advantageously not substituted,

A is a linear or branched alkylene group with 1 to 6 carbon atoms, wherein one carbon atom can be replaced by an oxygen atom or a sulphur atom,

a is an integer from 0 to 2 inclusive, preferably 0,

b is an integer from 1 to 3 inclusive.

The preferred aromatic vinyl monomers are styrene and divinylbenzene.

The composition of such substrate may also comprise other monomers and/or additives conventionally used in polymerizable compositions in order to adjust properties such as refractive optical index, yellow index, and Abbe number.

Surprisingly, it has been found that the coating composition described above adheres sufficiently to the acrylic substrate, without the need for a primer or a mechanical or physical (plasma or corona) pre-treatment to activate the surface and improve adhesion. Thus, according to an embodiment of this invention, the coating composition is applied directly to the substrate without first subjecting said substrate to any physical pre-treatment suitable for activating its surface.

The composition may be thermally hardened at a temperature ranging from 120° C. to 135° C., and preferably at 120° C. for a period of time of between 2 and 3 hours. In a preferred embodiment, before the curing step, a pre-curing step is performed at 70 to 85° C. for a period of time of between 5 and 20 minutes. The thickness of this coating may range from 1 to 10 μm, and preferably from 2 to 4 μm and its refractive index is usually of at least 1.55 and preferably of at least 1.58.

It is thus possible to obtain an ophthalmic lens, comprising an acrylic substrate coated with a hard coat having an abrasion resistance index above 3.

The ophthalmic lenses of the present invention include plano lenses, visors, and prescription (Rx) lenses. Such lenses may include finished lenses (F), semi-finished lenses (SF), progressive addition lenses (PAL), multifocal lenses, unifocal lenses and afocal lenses.

The ophthalmic lens optionally further includes at least one functional coating 3 which can be placed on the front side (i.e. on the hard-coat), on the back side of the lens, or and the front side and the back side of the lens. This functional coating may be selected from the group consisting of anti-reflective coatings, anti-UV coatings, polarizing coatings, color filtration coatings, photochromic coatings, antistatic coatings, tinted coatings, anti-fog coatings and anti-smudge coatings.

### EXAMPLES

This invention will be further illustrated by the following non-limiting examples which are given for illustrative purposes only and should not restrict the scope of the appended claims.

### Example 1

### Preparation of the Coated Lenses

A hard coating composition according to the present invention was first prepared, which included the following components, the amount of which is expressed in parts by weight:

TABLE 1
Amount of each component in the hard coating
composition

| Ingredient | Weight (g) |
|---|---|
| Glymo | 775 |
| Nitric acid | 0.00775 |
| Dowanol PM ® | 887 |
| Dowanol PMA ® | 887 |
| Ti(OC4H9)4 | 693 |
| CeO2 | 141 |
| NH4OH | 11.3 |
| Magenta dye | 29.7 |
| TMPTGE | 404 |
| BYK-306 | 4.5 |

The following four commercial hard coatings with a refractive index of 1.6 were also used as comparative compositions:

Composition 2: KH® 60 supplied by DON

Composition 3: TE0843® supplied by GAEMATECH

Composition 4: H 6010® supplied by JGC C&C

Composition 5: ST11TN-161® supplied by FINECOAT

The above compositions 1 to 5 were applied on acrylic substrates with a refractive index of 1.60.

The surface of the lenses was first cleaned and prepared by a usual sodic treatment in 5 to 20% NaOH aqueous solution at 50° C. to 60° C. with ultra-sonication during 3 to 15 min followed by rinsing with deionized water.

The hard-coat compositions tested were deposited by spin-coating on the convex side or by dip-coating on both sides of the substrate. The coated lenses were pre-cured at 70 to 85° C. for 5-20 minutes to remove the solvents and subsequently polymerized at 120° C. for 3 hours.

### Example 2

### Evaluation of the Performances of the Coated Lenses

The abrasion resistance and adhesion of the various coated lenses prepared in Example 1 were then evaluated. For the abrasion resistance measurement, the value obtained from the BAYER test carried out in accordance with standard ASTM F735.81 was used. A high value in the BAYER test corresponds to a high degree of abrasion resistance.

For the adhesion test, a crosshatch adhesion test (ISTM 02-010) was performed on the lenses in various conditions:
without specific conditioning of the lenses (test called “Adhesion”)
after having submitted the lenses to UV ageing for periods of time ranging from 40 h to 80 h (QSUN adhesion). UV ageing was performed in a xenon test chamber Q-SUN® Xe-3 from Q-LAB at a relative humidity of 20% (±5%) and at a temperature of 23° C. (±5° C.). The lens was introduced in the chamber and the convex side was exposed to the light. The lens was exposed to UV during 40 h and then subjected to the crosshatch test. If the lens passed the test, it was subjected again to 40 h UV exposure.

Results:

The results of the above tests are summarized in the table below:

TABLE 2
Performance of hard coatings on acrylic substrate

| | 1 | | | | |
|---|---|---|---|---|---|
| Composition | (invention) | 2 | 3 | 4 | 5 |
| HC | 2.4 | 3.5 | 2.7 | 2.6 | 2.4 |
| Thickness | | | | | |
| (μm) | | | | | |
| Refractive | 1.58 | 1.58 | 1.59 | 1.59 | 1.61 |
| Index | | | | | |
| HC Sand | Rc = 3.1 | Rc = 2.2 | Rc = 1.4 | Rc = 1.6 | Rc = 1.4 |
| Bayer | | | | | |
| Cross Hatch | 0 | 0 | 0 | 0 | 0 |
| QSun HC | Pass | Fail | Pass | Pass | Pass |
| Adhesion | | | | | |

As can be seen from this table, only the specific composition of this invention (Composition 1), provided both a good adhesion to the acrylic substrate, which remained after UV exposure, and a high abrasion resistance, which was superior to that obtained with the commercial hard coats tested (Compositions 2 to 5).

1. An ophthalmic lens comprising:
(a) an acrylic substrate;
(b) an anti-abrasion coating applied onto at least one surface of said substrate and obtained by curing a composition comprising the following constituents:
(a) a monomer compound of hydrolyzed alkoxysilane representing from 10 to 95 dry wt % of the dry weight of the composition;
(b) at least one colloidal metal oxide compound selected from titanium, zirconium, cerium, niobium, tantalum, and/or tin; and
(c) a polyglycidyl ether representing from 1 to 65 dry wt % of the dry weight of the composition;
with the proviso that the total amount of these constituents does not exceed 100 dry wt % of the dry weight of the composition.

2. The ophthalmic lens according to claim 1, wherein said coating composition further includes (d) a metal alkoxide.

3. The ophthalmic lens according to claim 1, wherein the polyglycidyl ether comprises a trimethylopropane triglycidyl ether (TMPTGE).

4. The ophthalmic lens according to claim 1, which has an abrasion resistance index above 3.

5. The ophthalmic lens according to claim 1, wherein the anti-abrasion coating has a refractive index of at least 1.55.

6. The ophthalmic lens according to claim 1, which further includes at least one functional coating placed on the anti-abrasion coating, said functional coating being selected from the group consisting of anti-reflective coating, anti-UV coating, polarizing coating, color filtration coating, photochromic coating, antistatic coating, tinted coating, anti-fog coating and anti-smudge coating.

7. A method for manufacturing an ophthalmic lens, comprising:
providing an acrylic substrate;
applying an anti-abrasion coating composition onto at least one surface of said substrate, said coating composition comprising the following constituents:
(a) a monomer compound of hydrolyzed alkoxysilane representing from 10 to 95 dry wt % of the dry weight of the composition;
(b) at least one colloidal metal oxide compound selected from titanium, zirconium, cerium, niobium, tantalum, and/or tin; and
(c) a polyglycidyl ether representing from 1 to 65 dry wt % of the dry weight of the composition;
with the proviso that the total amount of these constituents does not exceed 100 dry wt % of the dry weight of the composition; and
curing the coating at a temperature ranging from 120° C. to 135° C.

8. The method according to claim 7, further comprising a pre-curing step at 70 to 85° C. for a period of time of between 5 and 20 minutes.

9. The method according to claim 7, wherein said coating composition is applied directly onto said substrate, without first subjecting said substrate to any physical pre-treatment suitable for activating its surface.

10. The method according to claim 7, wherein the coating is cured at 120° C. for a period of time of between 2 and 3 hours.
